(19) United States
(12) Patent Application Publication
(10) Pub. No.: US 2016/0094028 A1
(43) Pub. Date: Mar. 31, 2016

(54) Arrangement and Method for Voltage Conversion

(71) Applicant: SELDÉN MAST AB, Västra Frölunda (SE)

(72) Inventor: Jan Karlsson, Västra Frölunda (SE)

(73) Assignee: Seldén Mast AB, Västra Frölunda (SE)

(21) Appl. No.: 14/785,333

(22) PCT Filed: Apr. 11, 2014
(86) PCT No.: PCT/SE2014/050450

§ 371 Date: Oct. 17, 2015

(30) Foreign Application Priority Data
Apr. 17, 2013 (SE) 1350482-4

(51) Int. Cl. H02J 1/00; H02M 3/04

(52) U.S. Cl. CPC H02J 1/00; H02M 3/04

(57) ABSTRACT

An arrangement for voltage conversion for a boat, for example a leisure boat, includes a DC voltage converter that converts a first DC voltage provided by a low voltage source, for example a battery, to a second DC voltage of at least 24 V for supplying at least one consumer with power. The arrangement also includes an interconnector for interconnecting the voltage converter and the at least one consumer, and a controller that is adapted to transfer the voltage converter between an idle mode, in which substantially no power is supplied to the at least one consumer, and an active mode, in which power is supplied.

### TECHNICAL FIELD

The present invention relates to an arrangement for voltage conversion which comprises a voltage converter for conversion of a first voltage to a second, higher, voltage, wherein said first voltage is a DC-voltage which is provided by a low voltage source, for example a battery, and wherein said second voltage is intended for supplying a number of consumers. The arrangement for voltage conversion is via interconnecting means in communication with a number of consumers.

### BACKGROUND

In for example motor driven leisure boats chargeable 12 or 24 V batteries are today used to supply different consumers. The batteries are normally charged by means of the generator of the motor, but they can also be charged using mains-driven chargers or different generators or charging aggregates driven in an appropriate manner. Modern leisure boats may have many different current consumers, starter motors, electrically driven winches, anchor windlasses, jib furlers, furling masts, internal lighting, lantern, boat heater etc. It is of utmost importance that the battery is charged in order to avoid situations in which a consumer which is needed can not be used, not the least at sea. Measures have been taken and technical progress has been made as far as reducing the current consumption of different consumers is concerned, but on the supplying side there has not been any larger progress. Another important aspect is that the dimensioning of the cables is determined by the power output, i.e. to achieve a desired power output, thick cables may be needed, which is unpractical both from a cable drawing point of view and also since they are bulky, and such cables are also expensive. Particularly the available space on for example leisure boats is very limited. Another aspect is that, for reasons of security, for example due to fire hazards and risks for accidents, comparatively thick cables are used.

### SUMMARY OF THE INVENTION

It is therefore an object of the present invention to provide a solution to the above mentioned problems and through which the current supply in for example a leisure boat can be improved or optimized. A particular object is to provide an arrangement through which the consumption generally can be reduced, whereby batteries are not discharged as fast as hitherto and current is not consumed unnecessarily.

It is an urgent need to, in addition to reducing the current consumption of different consumers, also find solutions to make a charged battery last longer, so that the situation also on the supplying side, as far as current supply is concerned, can be improved. A general object of the invention is to provide an arrangement through which power supply on for example a leisure boat can be improved and facilitated, and which enables an optimal usage of available battery capacity. A particular object is to provide an arrangement through which current supply versus energy consumption can be optimized, and that charge losses to the highest possibly extent can be avoided. It is particularly an object of the invention to provide an arrangement through which security can be increased for example as far as fire hazard, the risk of electrical shocks associated with an electrical supply system, on for example leisure boats.

Other objects are to provide a system which is easy to install, demands less space then hitherto known systems, which furthermore is easy to maintain and control, and flexible as far as installation and additions, replacement and removal respectively, of consumers is concerned, and which in addition thereto can be installed and run at a low cost.

Therefore an arrangement for voltage conversion as initially referred to is provided which comprises the characteristic features of the characterizing part of claim 1.

### BRIEF DESCRIPTION OF THE DRAWINGS

The invention will in the following be further described, in a non-limiting manner, and with reference to the accompanying drawings, in which:

FIG. 1 shows a block diagram of a system for power supply comprising an arrangement for voltage conversion according to a first embodiment of the invention,

FIG. 2 shows a block diagram of an arrangement according to an alternative embodiment of the invention,

FIG. 3 shows still another alternative embodiment of an arrangement according to the invention with separate cables to each consumer,

FIG. 4 shows still another embodiment of the invention wherein wireless communication is used,

FIG. 5 is a flow diagram showing the procedure upon desired activation of a consumer, a request for a resource, according to a first embodiment of the invention,

FIG. 6 is a flow diagram showing a procedure upon initiation of the activation of a consumer according to a second embodiment,

FIG. 7 is a flow diagram describing a procedure upon the initiation of the activation of a consumer, request for a resource, according to a third embodiment.

### DETAILED DESCRIPTION

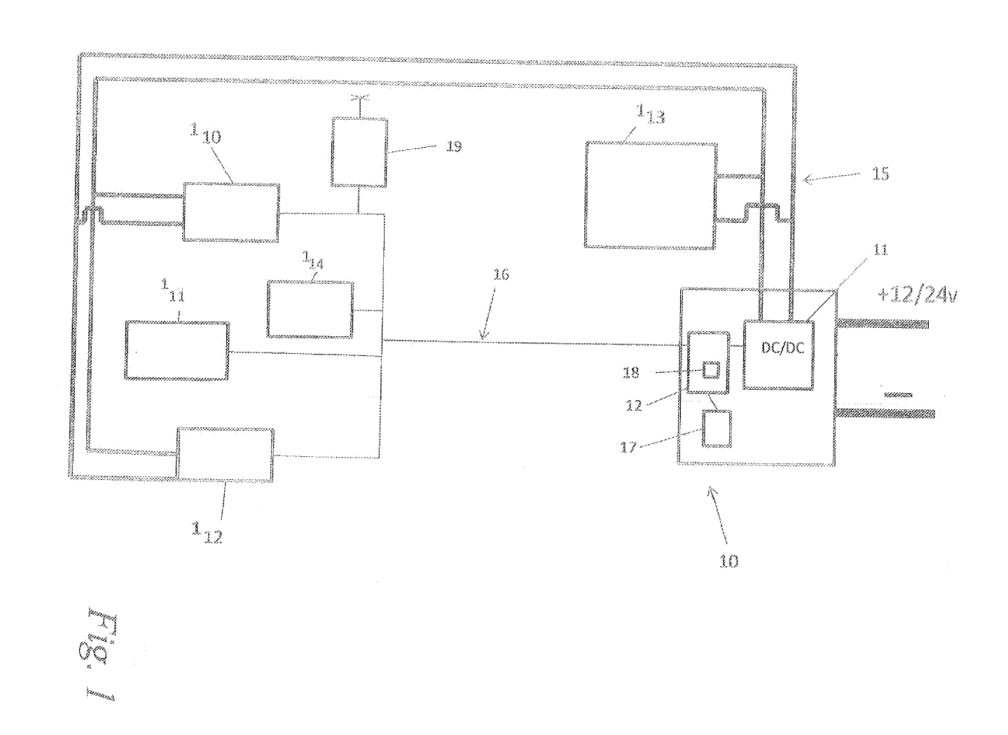

FIG. 1 shows a first embodiment of an arrangement for voltage conversion 10 according to the invention, which comprises a voltage converter 11, which for example may be connected to a battery delivering a first, lower voltage of between 10V and 30V, particularly a 12V or 24V battery. The voltage converter 11 comprised in the arrangement for voltage conversion is adapted to convert this first lower voltage, for example delivered from the battery, for example 12V or 24V, to a second, higher, voltage, for supplying a number of consumers with power.

The voltage converter 11 is a DC/DC converter and it is adapted to convert the first lower voltage to a second, higher DC voltage, which preferably does not exceed existing limits in force for being a high voltage, i.e. it is a low voltage, and, depending on applicable law, it may be somewhat below 50V or 60V, particularly 48V. In alternative embodiments the second voltage may of course be a high voltage, but then an adapted installation is required and more severe security requirements are applicable. In certain cases a more elaborate installation equipment etc. may be compensated for by e.g. enabling the usage of smaller motors, an increased admitted power output.

The arrangement for voltage conversion 10 comprises or is connected to a control function 12 controlling the voltage converter 11. Particularly it is adapted to be able to transfer the voltage converter between a first passive mode, which is an idle mode in which substantially no current is consumed, and an active mode in which one or more consumers can be supplied with power.

The control function 12 is adapted to be able to transfer the voltage converter from active to passive mode when/if given criteria are met, which for example may consist in no consumer having any outstanding request to be supplied or no consumer having consumed current during a given time period. There may of course also be other criteria, i.e. the essential being that the voltage converter only is in an active mode when power supply really is requested in order to save battery capacity and to make sure that no current is consumed unnecessarily, and to optimize the usage of available battery charge, particularly to avoid no charge losses.

The voltage converter can be woken up in different manners, for example by a user when a consumer is needed by means of a control button, a remote control or similar, or via, here, a CAN bus. If a CAN bus is not used for waking up (transferral to an active mode), a separate circuit can be used for this purpose.

Waking up particularly by means of a CAN bus can be done very quickly and only takes some, or a few, ms (milliseconds).

It is particularly advantageous if all information can be transferred by means of a CAN bus, with a CAN bus transfer a lot of, particularly all, information can be transferred using but one cable. This is also advantageous as such, since then only one cable is needed, which means that a lot of cabling can be avoided which is advantageous for several reasons, for cable drawing reasons, for reasons of cost, for reasons of space, and the risk of cable entanglement is avoided.

The arrangement for voltage conversion 10 as shown in FIG. 1 is connected to a number of consumers 1₁₀, 1₁₁, 1₁₂, 1₁₃ so that they can be supplied by means of a voltage converter 11. In the shown embodiment the interconnecting means comprises a, here denoted second, interconnecting network 15 for supply, provided between the voltage converter 11 and respective consumers comprising wires or cables.

Since the DC/DC converter 11 converts the lower battery voltage to a higher DC voltage, for example 48V, cables which are considerably thinner than cables used in hitherto known arrangements can be used, for which it actually is the thickness of the cables which constitutes a problem, particularly when they are to be drawn in locations where the space is limited, as for example on a leisure boat. Thick cables are on one hand bulky and on the other hand they have to be bent, which may constitute a problem and make an appropriate drawing of the cables difficult. Such cables are also expensive, which is another drawback. With an arrangement for voltage conversion according to the invention, the required cable dimension be reduced from for example 40 mm² to about 8 mm².

Another advantage is that electrical motors become more efficient if a higher voltage is used, in particular embodiments without entering into the high voltage range, where totally different requirements on equipment and on security systems are applicable. As referred to above, the second voltage may of course alternatively be a high voltage.

The arrangement for voltage conversion 10 also comprises a, here called first, interconnecting network 16 for communication between the control unit 12 of the DC/DC converter and the consumers 1₁₀, 1₁₁, 1₁₂, 1₁₃.

In the shown embodiment said first connecting network is a low speed CAN network (or a CAN bus) to which also a remote control 19 can be connected, and on which for example information can be sent from consumers indicating that the DC/DC converter needs to be activated or that they request to be supplied.

The CAN bus may be driven by the 48V system (here) which in some embodiments is provided by the building of a specially adapted circuit. Alternatively the CAN bus can be driven separately, in that case, however, it has to support the higher, by the voltage converter, up-converted voltage. In some embodiments the CAN bus uses the lower input voltage (for example 12V). The CAN cable may for example be run on 5V in the CAN circuit.

From the control unit 12 of the arrangement for voltage conversion, information can be sent indicating that power as requested by a consumer can be delivered or that only a lower supply power capacity is available etc. Communication can take place between a remote control 19 with a transmitting and a receiving functionality by means of which hence also a consumer can request to be supplied etc. as described above. Control buttons on the control panel 14 or similar may alternative be used for the transmission of a request.

Alternatively these functionalities can be provided on respective consumers (not shown here) or be provided, in addition to on one or more consumers, also by means of a remote control and/or a control panel with control buttons.

Particularly may, with an activation signal, power be reserved for a consumer, particularly the power that the consumer requires for operation.

The control function 12 is adapted to control the voltage converter 11 in order to admit supply of one or more consumers requesting to be supplied depending on available supplying capacity and fulfillment of given criteria.

In an appropriate manner the control function 12 continuously (or at discrete points in time, or on request) collects information about available capacity of the voltage converter and holds such information in information holding means 18. It may also be provided with such information in other manners.

Criteria may be given in different manners according to different embodiments. In a very simple embodiment may for example consumers be supplied in order, i.e. the consumer that first requests to be supplied will be supplied first, and if then further consumers need to be supplied, they are supplied depending on remaining capacity, or alternatively the available power is shared between them. According to another implementation previous consumers are disconnected, or are admitted power after the last requesting consumer has been admitted the power it needs, or the power is shared between them.

Preferably there is a possibility to, for example, via control panel 14 or via remote control 19, or by means of a direct control command using a button or similar on a consumer, give such a consumer priority and then terminate, or at lest reduce, the power supply of other consumers, since this consumer, at the actual moment in time, is a prioritized consumer which definitely has to be supplied.

In other embodiments the criteria comprise prioritizing information for different consumers and the prioritizing information can be held in holding means 17 which either may be comprised in the control unit or which may communicate therewith.

The priorities, and the criteria, may either be fixed or dynamical, i.e. variable. It is also possible to add and to remove consumers and to give them a certain individual priority according to different priority classes etc. In the prioritizing information may also be included or held information regarding to which extent, or if, power supply sharing shall be applied, so that it for example may be indicated whether power sharing should be applied if not sufficient power is available when a consumer requests to be supplied and if only a fraction of the requested power is available, and if and how in such a case the available capacity is to be shared between different consumers, about which consumers allow sharing etc.

The prioritizing and the allocation of power admitted to be supplied to different consumers can be controlled in many different manners, ranging from exclusively manually to automatically, mechanical control or computer controlled.

In some embodiments temporary changes are allowed, for example up or down prioritizing of a consumer, which for example shall be possible to invoke by means of a quick command on the voltage converter, on the consumer, using the remote control or the control panel, or using one or more thereof.

Consumers can be added, replaced, removed, and, manually or automatically, be given different priorities.

In an advantageous embodiment consumers are given an identity when mounted, upon installation. This can be done in different manners, for example by means of a login procedure in which consumers are given an identity. For example may, for activation, at mounting, an activation button which is connected to a consumer or to a user be used. Upon activation of the activation button, a request is sent to (the user and) the DC/DC converter, or only to the user, who then has to send a message to the DC/DC converter over the communication network.

Mounting and start-up may for example take place in such a manner that, first all components, consumers, are mounted, a cable is drawn, current is switched on, queries are sent out to all mounted consumers, which thereupon are to return a response. Then they are given a name or an identity. In advantageous embodiments the voltage converter is provided with a display and a user interface.

If instead of a CAN bus a wireless communication network is used, this procedure may be carried out in a similar manner. If instead discrete cables are used in a communication network may for example so called jumper cables and micro switches with for example a five position code or any other appropriate code be used.

By implementing prioritizing, a smaller voltage can be used than if a voltage converter is used which allows all consumers to be connected at the same time, which is advantageous.

Priorities of consumers may in some more advanced embodiments be programmed, for example in connection with the mounting as described above.

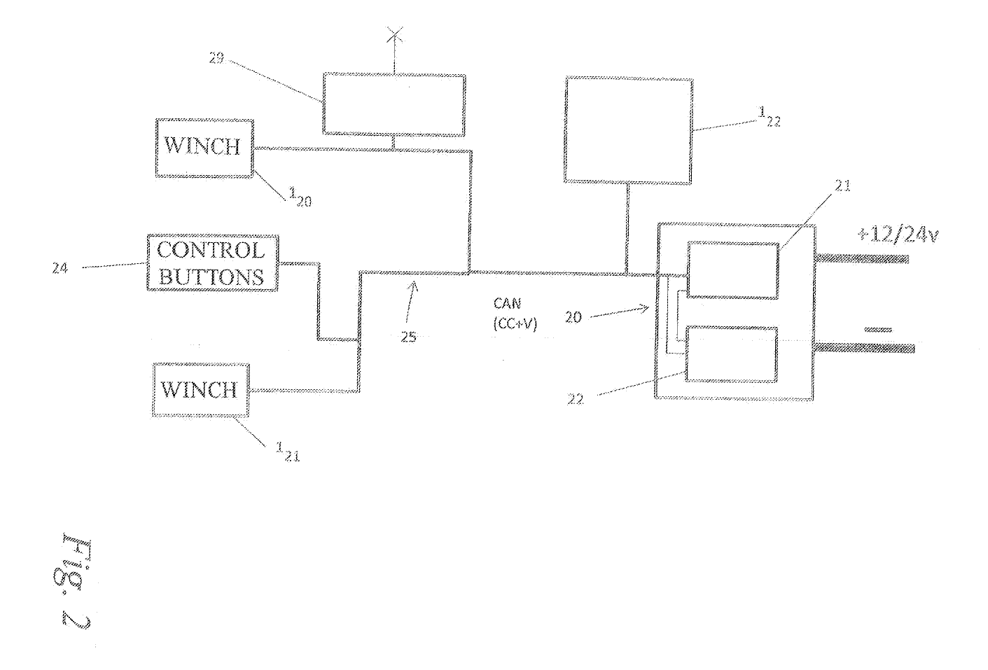

FIG. 2 shows an alternative embodiment comprising an arrangement for voltage conversion 20 with a voltage converter 21 for supply of consumers 1₂₀, 1₂₁, 1₂₂, wherein 1₂₂ is taken to denote other consumers. The control unit 22 here comprises information collecting or information holding means adapted to hold information about remaining available capacity, and storing means adapted to hold information about criteria, particularly prioritizing information, as described above.

The main difference between this embodiment and the embodiment described above according to FIG. 1 is that, herein, for the CAN bus, the first connecting means 25 are used and, for communication (CC) with the control unit as well as for power supply (V) a common, combined network is used. In this embodiment are also shown the remote control 29 and a control panel 24. In other aspects the arrangement functions as described above and can be varied in similar manners.

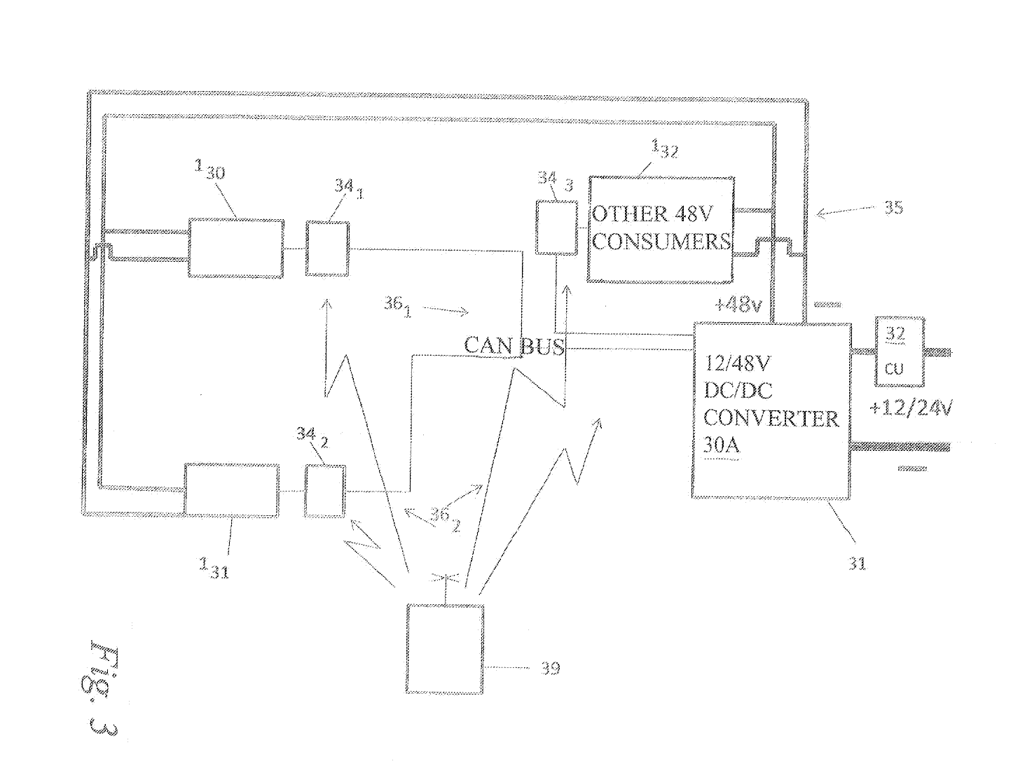

FIG. 3 shows still another embodiment of an arrangement for voltage conversion 31, here with a separate control unit 32, connected to, or comprising, information holding means and storing means (not shown) for holding information about current supply capacity and prioritizing information respectively (and identity information concerning consumers). The control unit is here connected at the feeding voltage input from the battery.

The arrangement for voltage conversion is via supply connection connected to consumers 1₃₀, 1₃₁, 1₃₂ (1₃₂ schematically referring to other 48V consumers) for power supply as described above, and the consumers are provided with respective control means, for example control buttons or similar 34₁, 34₂, 34₃. Control means comprising control buttons are of course not indispensable, but some consumers may be equipped therewith. Such control means may for example be provided in association with a consumer. Alternatively one or more consumers may be controllable exclusively, or as a complement, by means of a remote control 39. It is here indicated that the remote control is capable of controlling all consumers, or their control means, but of course the case may be that only one or some of the consumers is/are controlled by means of a remote control, or alternatively that none can be.

Communication with the control unit 32 may in some embodiments be provided by means of an interconnecting network 36₁ which in the shown embodiment comprises discrete cables which are connected to respective consumers, or their separate control means. Using discrete cables, identity as well as prioritizing information, is then directly be provided to the control unit 32, which for example may be equipped with contact means for certain consumers or for a certain priority in a simple embodiment.

Of course may also in this case, in which discrete communication cables are used, collection of control information take place by means of direct indication or feeding the control unit, or be programmed in the control unit if it is a more advanced control unit.

In simpler embodiments may, independently of location and possible implementation of the control unit, discrete cables from respective consumers be located on different connector pins on an input to the arrangement/control unit, for example in such a manner that different connector pins are used for different priorities. Alternatively identity and/or priority can be programmed at connection of a respective cable from a consumer. Also in this embodiment a wireless communication network 36₂ is used as a complement to the discrete communication network 36₁, or can be used for certain consumers which support wireless communication.

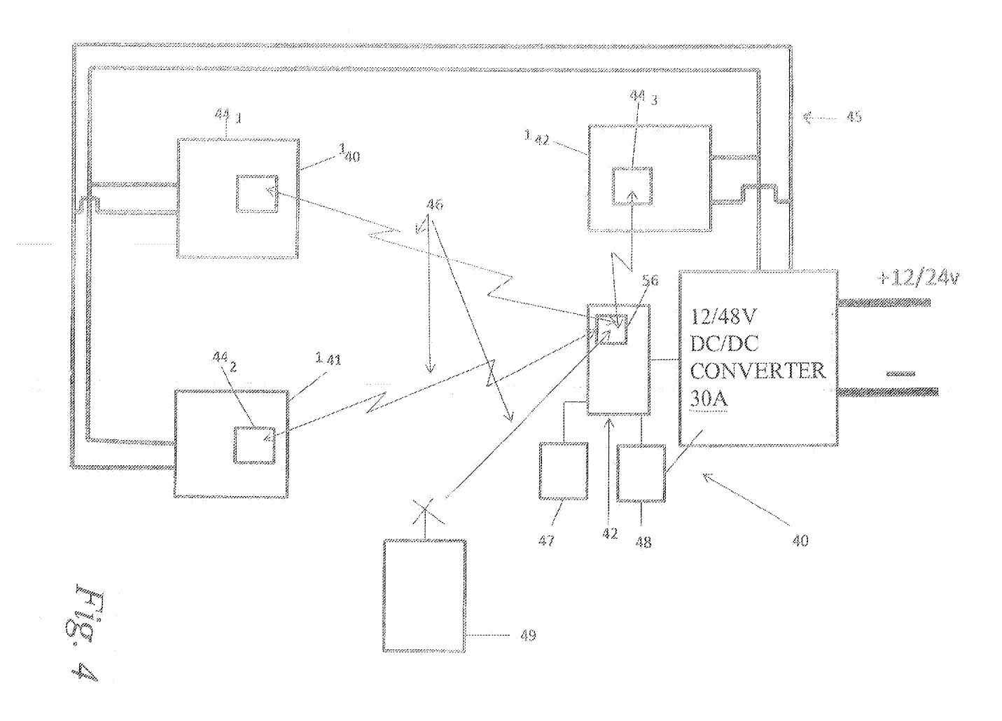

In FIG. 4 is shown a further example of an arrangement for voltage conversion 40 which comprises a voltage converter 41, which by means of a second interconnecting means 45 can supply a number of consumers 1₄₀, 1₄₁, 1₄₂, which here are provided with communication units 44₁, 44₂, 44₃ which enable wireless communication with a control unit 42, i.e. in this embodiment the first communication means for communication exclusively is made up of a wireless network 46. The control unit here also comprises a module 56 for wireless communication, information holding means 47, and priority information storing means 48 as described above.

It should be clear that in all embodiments the voltage converter may comprise a unit comprising all required functionalities concerning storing of information, handling of information etc. For illustrative reasons, however, the control unit is only shown as being arranged separately from the voltage converter, which however also relates to an advantageous embodiment.

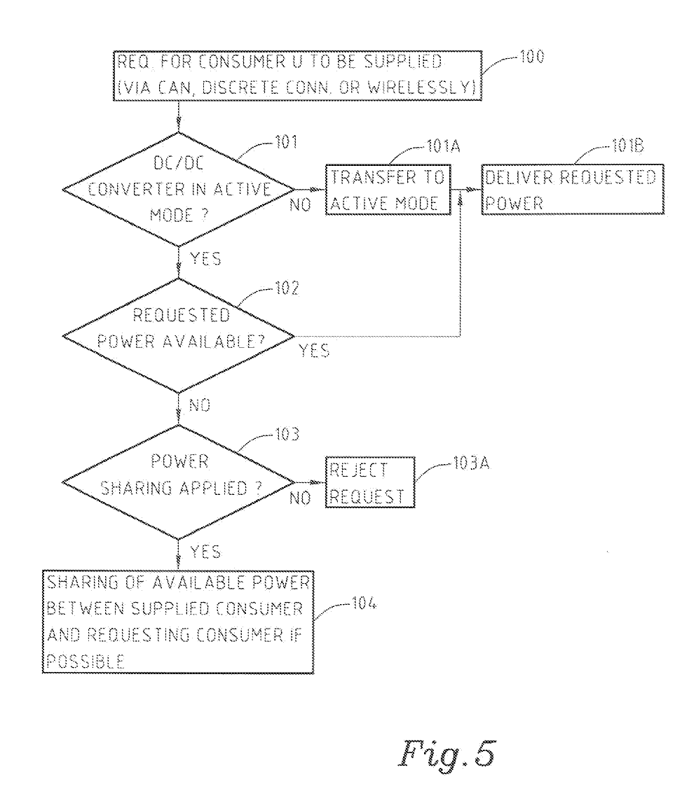

FIG. 5 is a schematical flow diagram describing the procedure when a consumer U sends a request to be supplied, 100. This request can be sent over CAN, over a discrete connection, or a consumer simply is connected, or a user activates a button, by manual programming the control unit, or wirelessly by the user using a remote control. The request is sent to/processed in the control unit which examines if the DC/DC converter is in an active mode or not, 101. This can take place in different manners, for example by checking if the other, higher, voltage is on the feeding cable from the voltage converter.

If it is not in an active mode, the control unit transfers it to an active mode, 101A, for example by activating a switch or on a chip. Then the consumer is admitted to take out the requested power 101B, i.e. information is sent to consumer U that it is admitted the requested power (current) on condition that it is available, which it however is expected to be since the DC/DC converter was in a passive mode.

If on the other hand the DC/DC converter was found to be in an active mode, it may be examined if the requested amount of power is available, 102, by comparing requested amount of power with updated information concerning currently available power held in information holding means. If the requested amount of power is available, it is delivered, i.e. the request is admitted, 101B. If the requested power, however, is not available from the DC/DC converter, it is examined if power sharing is applied, 103 (either generally or if it is to be applied in the current case and/or for the requesting consumer). If not, the request is rejected and information thereon is sent on CAN to consumer U, 103A.

If on the other hand power sharing is applied, available power is shared between already supplied consumer and requesting consumer, if this is possible, 104. This can be done in different manners, either the power (current) is shared or, in information holding means information is held about how much power should be guaranteed a certain consumer, or, if the consumers belong to different priority classes, how available supply capacity in such a case is to be distributed between the consumers. This can be done in many different manners depending on which information actually is held. In a simple case the requesting consumer simply is admitted the remaining power output.

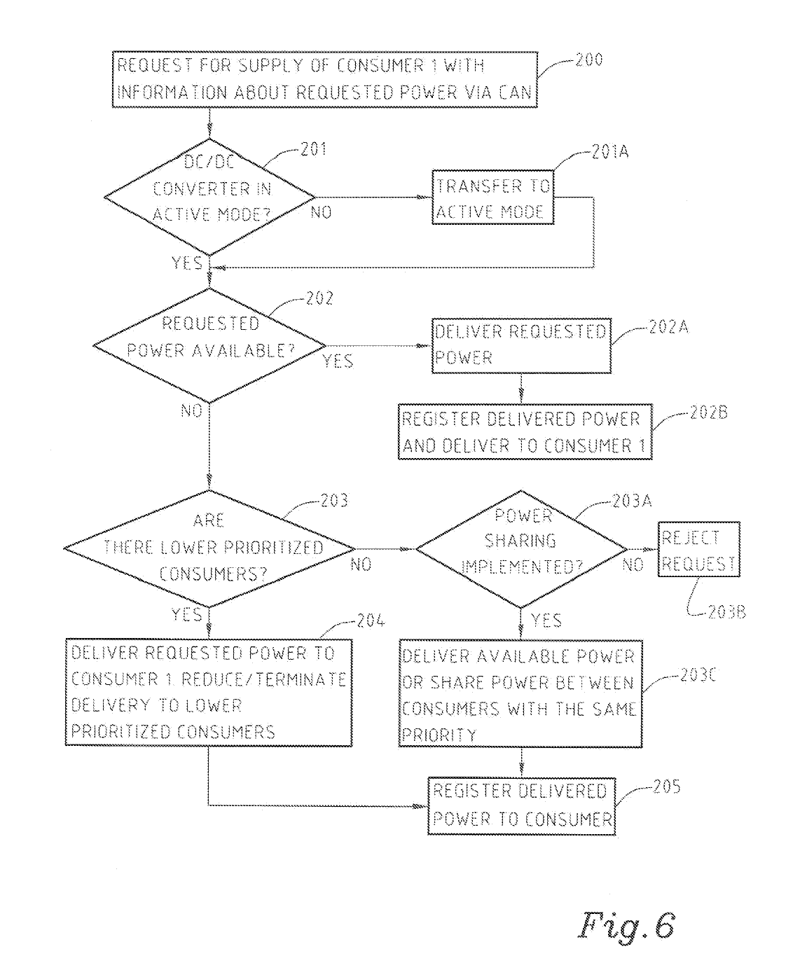

FIG. 6 is a flow diagram illustrating an alternative embodiment according to the invention and it shows an example on how prioritizing information can be held and used. It is assumed that the request for supply of consumer 1 is sent on a CAN bus, wherein the request contains information about the requested power output, 200. Then it is examined if the DC/DC converter is in an active mode, 201, and if not, it is transferred to active mode, 201A, as described with reference to FIG. 5, and it is examined if the requested power output is available, 202. If the requested power output actually is available, the requested power output is delivered (supply admitted) 202A, information thereon is sent on CAN to the consumer and registered in information holding means in or in connection to a control unit arranged in, or connected to, the voltage converter; either that consumer 1 was admitted the power output 202B, or in a simplified embodiment, that a certain power output was delivered to a consumer.

If, on the other hand, the requested power is not available, it is examined in communication with storing means holding prioritizing information if there are other consumers which have a lower priority and which currently are being supplied, 203. If it is then established that there are no other lower prioritized consumers being supplied, it is examined if power sharing is applied, 203A; if not, the request is rejected 203B, and information thereon is sent on CAN to consumer 1.

If, however, power sharing is applied, either available power is delivered or the power is shared between consumers having the same priority, or in any other manner, according to given prioritizing information, 203C. Then it is registered what power was delivered to consumer 1. If, on the other hand, it is determined that there are lower prioritized consumers which currently are being supplied, requested power is delivered (request admitted) to consumer 1 whereas the power supply of lower prioritized consumers either is terminated or reduced to the required extent, 204, and it is registered which consumer is delivered what power (or current).

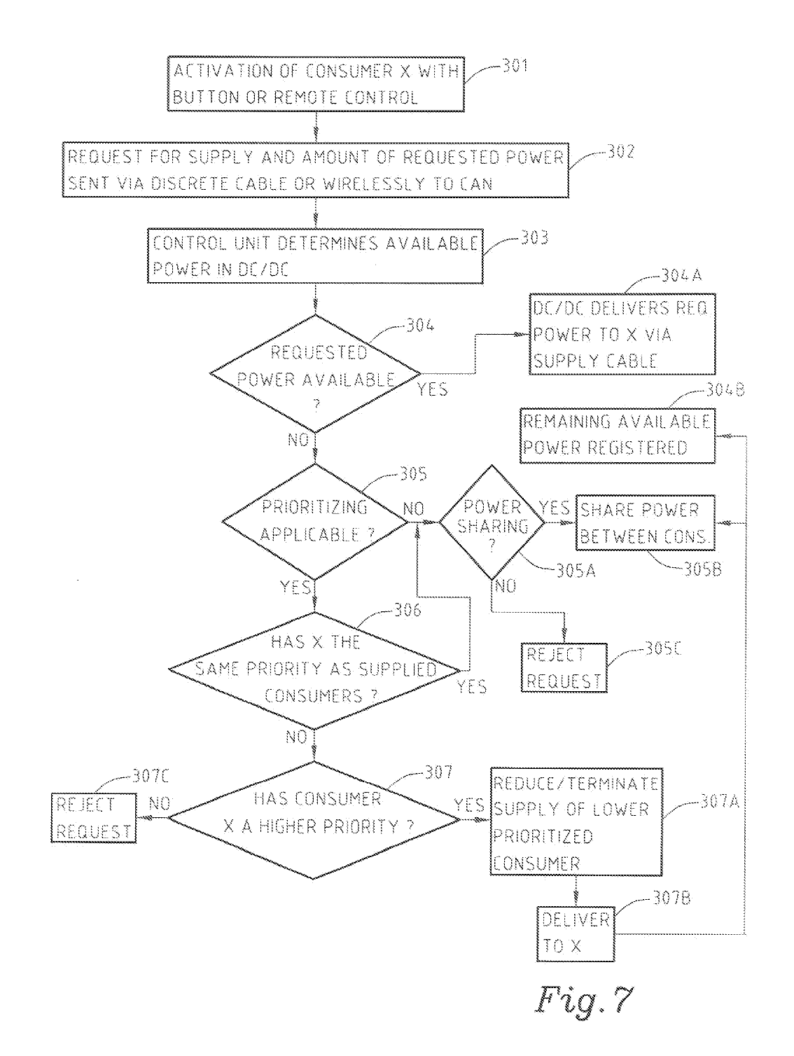

In FIG. 7 still another alternative embodiment according to the invention is shown. It is here supposed that a consumer X is activated via a control button or similar, which either may be provided on the consumer itself or on the control panel, stand-alone or in connection to the voltage converter or its control unit, or via a remote control, 301. A request for power output including information about requested power (current) is either sent over a discrete cable or wirelessly to the control unit CU of the arrangement for voltage conversion, 302. The control unit determines or fetches information about available power in the DC/DC converter, 303. If the requested power is available, 304, consumer X is admitted the requested power output from the DC/DC converter via the supply network 304A, i.e. consumer X is informed that a given power output or a desired power output is admitted. Then information about available remaining power is registered in information holding means 304B. If however the requested power is not available, it is examined if prioritizing is applied, 305. If prioritizing is not applied, it is examined whether power sharing is applied, 305A. If this is not the case, the request is rejected, 305C, i.e. consumer X is not admitted any power supply and consumer X is directly or indirectly informed thereon.

If, however, it is established that prioritizing is applied, it is examined if consumer X has the same priority as one or more already supplied consumers. If yes, it is examined if power sharing is implemented, 305A, or if other criteria are applicable, for example if the first requested consumer should be admitted supply or if a later, or the latest requesting consumer instead should be admitted for power supply etc. Many alternatives are possible. If, however, there is no other consumer having the same priority, it is examined if consumer X has a higher priority, 307. If not, the request is rejected, i.e. consumer X is not admitted for power supply 307. If consumer X however has a higher priority, the supply of lower prioritized consumers 307A is reduced or terminated, and consumer X is admitted for power supply, 307B, which is registered, 304B.

It should be clear that the invention is not limited to the explicitly described embodiments but that it can be varied in a number ways within the scope of the appended claims. The arrangement is intended for use on a boat, particularly a leisure boat, where the requirements on power being available for supply are high, for example for a longer sailing trip, when it can be disastrous if, for important consumers, there is no power available. Particularly leisure boats are often used during a longer period of time but not as frequently as for example a car, and they are used in a very exposed, corrosive environment due to humidity and salt water. Therefore the voltage converter may with advantage be arranged inboards or be enclosed, and in such a manner that as many components as possible, for example contacts and contact points for example between cables are well protected. If, and when, that is not possible, preferably Au (gold) plated contacts are used.

It should also be clear that the content of the described embodiments freely can be varied and combined.

1.-24. (canceled)

25. An arrangement for voltage conversion, comprising:
a voltage converter configured to convert a first voltage to a second voltage that is higher than the first voltage, wherein the first voltage is a direct-current (DC) voltage provided from a low-voltage source, and the second voltage is a DC voltage of at least 24 volts for supplying at least one consumer with power;
means for interconnecting the voltage converter and one or more consumers; and
a controller configured to transfer the voltage converter between an idle mode, in which substantially no power is supplied to the at least one consumer, and an active mode, in which the at least one consumer is supplied with power;
wherein the arrangement is configured for deployment on a boat, and the at least one consumer includes at least one of a winch, a jib furler, a furling mast, an anchor windlass, and a bow thruster.

26. The arrangement of claim 25, wherein the controller function transfers the voltage converter from the active mode to the passive mode according to at least one criterion that includes that no consumer has an outstanding request to be supplied and that no consumer has consumed any power during a given time period.

27. The arrangement of claim 25, wherein the controller is configured to control the voltage converter to supply power depending on at least one of an available power supply capacity and at least one predetermined criterion, and if the voltage converter is in the passive mode, the controller transfers the voltage converter to the active mode upon registration of a consumer needing to be supplied with power.

28. The arrangement of claim 26, wherein the at least one criterion includes respective priorities of consumers and a respective order of consumers.

29. The arrangement of claim 25, wherein the second DC voltage is less than 60 volts.

30. The arrangement of claim 27, wherein the controller is configured to access stored information about consumer identity and priority, and if a consumer having a higher priority requests to be supplied, the controller interrupts or reduces power being supplied to a lower prioritized consumer when the power supply capacity is not enough.

31. The arrangement of claim 30, wherein the controller is configured to communicate with a first memory for information about the voltage converter, available current, and available power supply capacity.

32. The arrangement of claim 31, wherein the controller is configured to communicate with a second memory for information defining which consumer is to be supplied to what extent under what circumstances, and information concerning power supply sharing for consumers having the same priority.

33. The arrangement of claim 32, wherein the controller is configured to reserve power for a consumer upon request.

34. The arrangement of claim 33, wherein the information concerning power supply sharing includes information about whether consumers having the same priority are disconnected from power supply or are supplied less power in response to a request from a higher-priority consumer.

35. The arrangement of claim 33, wherein the information defining which consumer is to be supplied to what extent under what circumstances provides that consumers are supplied in order of requesting power.

36. The arrangement of claim 32, wherein the first memory is configured to register a request to be supplied from a consumer or activation of a consumer.

37. The arrangement of claim 25, wherein the interconnecting means comprises a first interconnecting network that includes discrete cables for communication between the voltage converter and the at least one consumer, and a second interconnecting network for supplying power to the at least one consumer.

38. The arrangement of claim 25, wherein the interconnecting means comprises a wireless communication network between the controller and the at least one consumer, and a second interconnecting network for supplying power to the at least one consumer.

39. The arrangement of claim 37, wherein the first interconnecting network comprises a controller area network (CAN) bus for transferring information concerning at least requests for power supply or activation by consumers to the controller and for sending control information from the controller.

40. The arrangement of claim 39, wherein the at least one consumer includes a receiver for receiving a control signal from the controller and a transmitter for indicating at least switching on/switching off of the at least one consumer.

41. The arrangement of claim 40, wherein the CAN bus provides, upon activation of a consumer or reception of the control signal, a consumer request to the controller.
